(19) United States
(12) Patent Application Publication
(10) Pub. No.: US 2014/0205418 A1
(43) Pub. Date: Jul. 24, 2014

(54) BIG WHEEL CARGO MODULE

(71) Applicant: GM GLOBAL TECHNOLOGY OPERATIONS LLC, Detroit, MI (US)

(72) Inventor: Chet R. Wisniewski, Royal Oak, MI (US)

(73) Assignee: GM Global Technology Operations LLC, Detroit, MI (US)

(21) Appl. No.: 13/746,183

(22) Filed: Jan. 21, 2013

(51) Int. Cl. B62D 51/04; B65G 67/24; B62B 1/00; B65G 67/04

(52) U.S. Cl. CPC B62D 51/04; B65G 67/04; B65G 67/24; B62B 1/00
USPC 414/800; 280/78; 280/47.34; 180/19.1

(57) ABSTRACT

One variation may include a module may include a cargo cavity and at least one wheel. The module may be constructed and arranged to aid in the transportation and delivery of cargo or freight over terrain or rough surfaces.

### TECHNICAL FIELD

The field to which this disclosure generally relates includes freight and cargo transportation.

### BACKGROUND

Freight and cargo transportation products and methods commonly desire simplified methods and apparatus', ease of mobility, and expedited deployment.

### SUMMARY OF STANDARD VARIATIONS

One variation may provide a module including a cavity and at least one wheel. The module may be constructed and arranged to aid in the transportation and delivery of cargo or freight.

One variation may provide a module including a cavity, a handle, a motor, and a plurality of wheels. The module may be constructed and arranged to facilitate the transportation and delivery of cargo or freight whereby the handle may be constructed and arranged to aid a user in guiding or directing the module and the motor may drive the wheels.

One variation may provide a module and a loading stall, the module including a cavity, a handle, a motor, and a plurality of wheels, the loading stall being constructed and arranged to receive or deliver the module to or from the loading stall.

Other standard variations will become apparent from the detailed description provided hereinafter. It should be understood that the detailed description and specific examples merely disclose standard variations of the invention and are intended for purposes of illustration only and are not intended to limit the scope of the disclosed inventions.

### BRIEF DESCRIPTION OF THE DRAWINGS

Standard variations will become more fully understood from the detailed description and the accompanying drawings, wherein:

FIG. 1A is a perspective view illustrating a product and a method according to one variation;

FIG. 1B is a perspective view illustrating a product and a method according to one variation;

FIG. 1C is a perspective view illustrating a product and a method according to one variation;

FIG. 1D is a perspective view illustrating a product and a method according to one variation; and

FIG. 2 is a schematic illustration of one variation.

### DETAILED DESCRIPTION OF STANDARD VARIATIONS

The following description of variations is merely illustrative in nature and is in no way intended to limit the inventions, applications, or uses.

In a number of variations, the disclosed inventions may have various geometric, dimensional, and structural configurations.

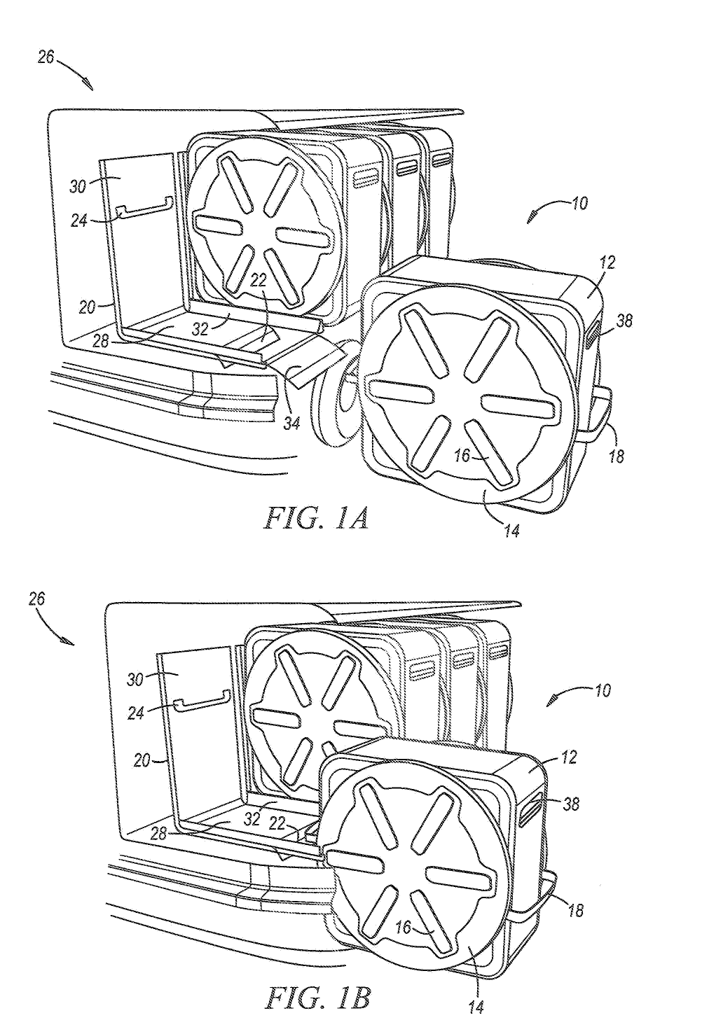

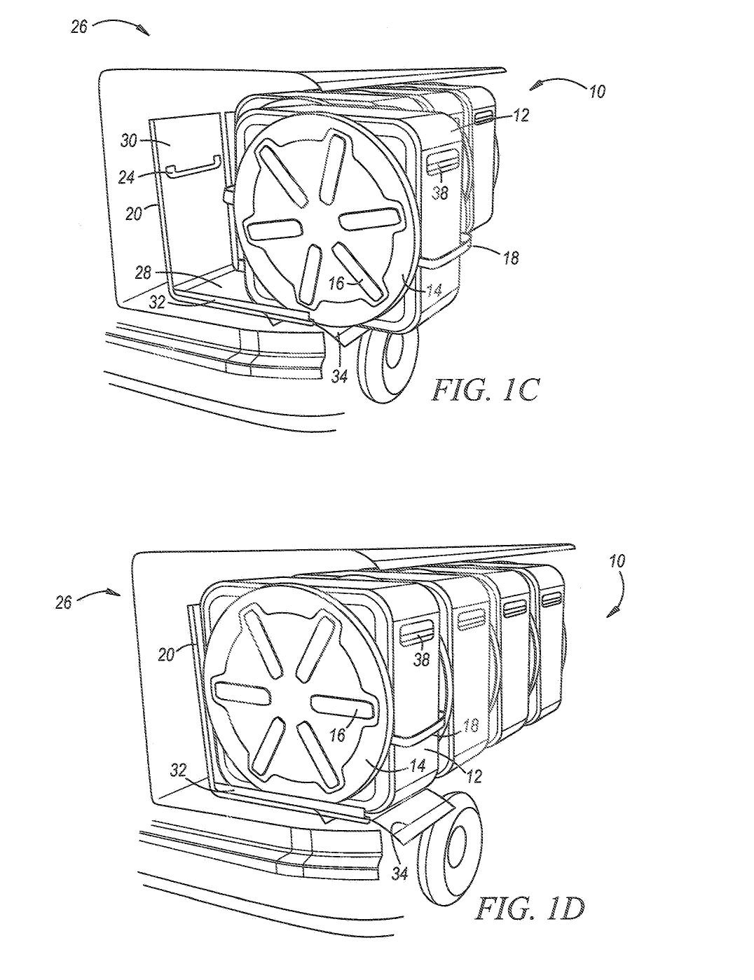

Referring to FIG. 1A, one variation may provide a module 10 for carrying goods, the module 10 may include a body 12, at least one cavity (not shown), at least one wheel 14, at least one wheel detail 16, and at least one handle 18; the body 12 defining at least one aperture 38. A loading stall 20 may be provided; the loading stall 20 may have a latch assist 22 and a locking mechanism 24. The loading stall may include a floor 28, and wail 30, a channel or plurality of channels 32, a ramp 34, and a partial wall 36 that may be pivotally hinged on the floor 28. In one variation, the loading stall 20 may be mounted on or defined by a vehicle 26. In FIG. 1A, a user may move or direct the module 10 towards the loading stall 20 when loading the module 10 into the loading stall 20. In one variation, the wheel 14 may have a diameter greater than the length or height of the body 12 of the module 10.

Referring to FIG. 1B, one variation may provide for a user moving or directing the module 10 towards the loading stall 20 when loading the module 10 into the loading stall 20 wherein the at least one wheel detail 16 may engage the latch assist 22, the plurality of channels 32, the ramp 34, or the loading stall 20 in preparation for loading the module 10 into the loading stall 20.

Referring to FIG. 1C, one variation may provide for a user moving or directing the module 10 into the loading stall 20 wherein the at least one wheel detail 16 engages the latch assist 22, the plurality of channels 32, the ramp 34, or the loading stall 20; the loading stall 20, latch assist 22, ramp 34, or plurality of channels 32 being constructed and arranged to facilitate ease of loading or unloading of the module 10 into or from the loading stall 20. In one variation, the module 10 may include a motor (not shown) constructed and arranged to drive the at least one wheel 14, whereby the driving of the at least one wheel 14 facilitates the engagement of the at least one wheel detail 16 and the latch assist 22, ramp 34, plurality of channels 32, or loading stall 20.

Referring to FIG. 1D, one variation may provide for a user locking or fixing the module 10 in place within the loading stall 20. The user may move the at least one handle 18, the handle being constructed and arranged to engage the locking mechanism 24 of the loading stall 20 thereby temporarily fixing the module 10 in position within the loading stall 20. According to another variation, the partial wall 36 that may be pivotally hinged on the floor 28 may be lowered to facilitate the loading of the module 10 into the loading stall 20 or lowered to facilitate the unloading of the module 10 from the loading stall 20. In one variation, the loading stall 20 may attached to a vehicle 26.

In a similar way, one variation may provide a user unloading the product 10 from the loading stall 22, whereby the user may move the at least one handle 18 to disengage the handle 18 from the locking mechanism 24 and removing the module 10 from the loading stall 20. In one variation, removal of the module 10 from the loading stall 20 may include the at least one wheel detail 16 engaging the latch assist 22, ramp 34, or plurality of channels 32 such that the module is removed from the loading stall 20 efficiently. One variation may provide a module 10 comprising a motor, the motor being constructed and arranged to drive the at least one wheel 14.

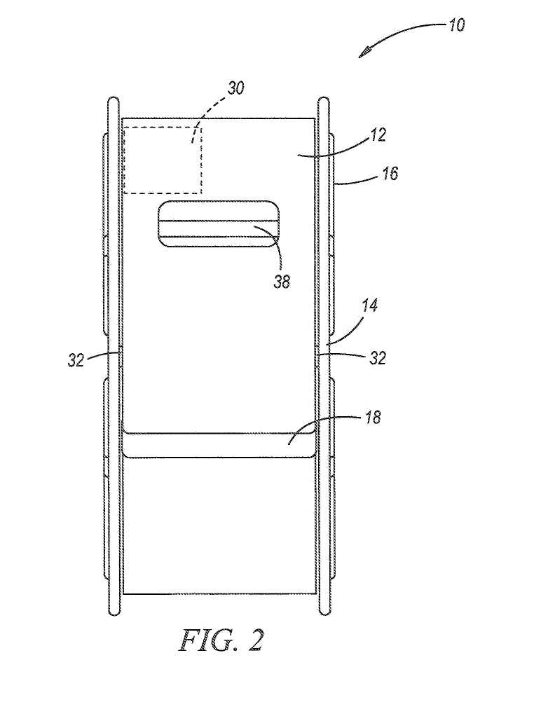

Referring to FIG. 2; the motor 30 may be connected to an axle 32 and the axle 32 may be connect to the wheel 14 to rotate the wheel 14.

According to one variation, a module may include at least one cavity constructed and arranged to contain or hold cargo or freight. The module may include at least one wheel and a motor, the motor being constructed and arranged to power movement of the wheel.

According to one variation, a module may include a plurality of cavities constructed and arranged to contain or hold cargo or freight. The module may include a plurality of wheels and a motor, the motor being constructed and arranged to power movement of the plurality of wheels.

One variation may provide a module that may include a cavity and at least one wheel, the one wheel being constructed and arranged to facilitate ease of loading and unloading from a transportation vehicle.

One variation may provide for at least one wheel being constructed and arranged to facilitate ease of loading and unloading from a transportation vehicle as well as ease of mobility and navigability of rough terrain or surfaces.

One variation may provide a module that may include a cavity, a handle, and at least one wheel, the one wheel being constructed and arranged to facilitate ease of loading and unloading from a transportation vehicle.

Another variation may provide for at least one wheel, the wheel having at least one wheel detail, the wheel detail being constructed and arranged to facilitate ease of loading and unloading from a transportation vehicle where the transportation vehicle may include a loading stall, the loading stall being constructed and arranged to receive the wheel detail.

In one variation, the wheel may include a circular face and a wheel detail. The wheel detail may be a protrusion extending from the circular face. According to one variation, the wheel detail may be a protrusion of any shape or geometry on the circular face of the wheel. In another variation, the wheel detail may be a protrusion on the circular face, the protrusion extending radially from the center of the circular face to the outer circumference of the circular face.

In another variation, the wheel detail may be an indentation of any shape or geometry on the circular face of the wheel, the indentation extending radially from the center of the circular face to the outer circumference of the circular face. According to one variation, the wheel detail may be an indentation of any shape or geometry on the circular face of the wheel, the indentation extending radially from the center of the circular face to the outer circumference of the circular face.

In yet another variation, the at least one wheel may have a diameter, and the diameter of the wheel may be larger than the largest dimension of the body.

In another variation, the at least one wheel may have a diameter, and the diameter of the wheel may be equal to the largest dimension of the body.

In another variation, the at least one wheel may have a diameter, and the diameter of the wheel may be equal to or less than the largest dimension of the body.

In another variation, the wheel may be constructed and arranged to facilitate ease of mobility and navigability over rough terrain or surfaces.

In one variation, the module may include a motor, the motor may be integrated with the at least one wheel and constructed and arranged to drive rotation of the at least one wheel. The motor may be any mechanism that converts energy into mechanical action such as, but not limited to, an electric motor.

In one variation, the module may include a motor, the motor may be integrated with the at least one wheel and constructed and arranged to drive the wheel and facilitate ease of loading and unloading from a loading stall, the loading stall being constructed and arranged to receive the wheel and/or wheel detail whereby when the motor drives the wheel, the wheel detail engages the loading stall such that the module may be received or delivered from the loading stall.

One variation may include a module that may include a body, the body may define an aperture constructed and arranged to allow the input of cargo or freight into the cavity of the body.

According to one variation, the module may include a sensor or plurality of sensors constructed and arranged for detecting when the cavity is full of cargo or freight and an indicator may be located on the outside of the body of the module constructed and arranged to indicate to a user that the cavity is full of cargo or freight.

One variation may provide a loading stall, the loading stall being constructed and arranged to receive or deliver the module whereby the loading stall is engaged with a wheel detail.

Another variation may provide a loading stall, the loading stall comprising an assist latch, the assist latch being constructed and arranged to engage the wheel detail to receive or deliver the module to or from the loading stall.

In one variation, the module may include a motor, the motor may be integrated with at least one wheel and constructed and arranged to drive the wheel and facilitate ease of loading and unloading from a loading stall, the loading stall comprising an assist latch, the assist latch being constructed and arranged to receive the wheel and/or wheel detail whereby when the motor drives the wheel, the wheel detail engages the assist latch such that the module may be received or delivered from the loading stall.

In another variation, the module may include a body defining at least one cavity, at least one wheel, at least one motor, and a vehicle. The at least one cavity may be constructed and arranged to contain or hold cargo or freight. The motor may be constructed and arranged to power the at least one wheel. The at least one wheel may include at least one wheel detail, and the at least one wheel may be constructed and arranged to assist a user in the loading and unloading of cargo from the cavity and to facilitate ease of mobility and navigability of the module over terrain or rough surfaces. The vehicle may be constructed and arranged to receive or deliver the module and the at least one wheel detail may be constructed and arranged to facilitate the reception or delivery of the module into or out of the vehicle.

In another variation, the module may be loaded into the vehicle wherein a user may move or direct the module towards the vehicle. The vehicle may have a bed that may have an edge. During loading of unloading, the at least one wheel detail may engage the edge, the motor may drive the wheel, and the module may be loaded or unloaded into or out of the vehicle.

In another variation, a loading stall may be provided, the loading stall being constructed and arranged to receive or deliver the module whereby the loading stall is engaged with a wheel detail, the loading stall being attached to a transportation vehicle. The transportation vehicle may be, for example but not limited to, an automobile, a rail vehicle, an aerospace vehicle, or a nautical vessel. The loading stall may be attached by, for example but not limited to, mechanical means, chemical bonding means, attached in a one-piece design configuration, or other suitable means.

In another variation, a loading stall may be provided, the loading stall being constructed and arranged to receive or deliver the module whereby the loading stall is engaged with a wheel detail, the loading stall being attached to fixed structure. A fixed structure may be, for example but not limited to, a wall, a floor, or other suitable structure. The loading stall may be attached by, for example but not limited to, mechanical means, chemical bonding means, attached in a one-piece design configuration, or other suitable means.

One variation may provide a method for unloading and loading a module from a loading stall, the module having at least one wheel and a handle, the wheel having at least one wheel detail, the wheel detail being constructed and arranged to facilitate ease of loading and unloading from the loading stall, the loading stall being constructed and arranged to receive the wheel detail. The method may include a user directing the module towards the loading stall and facilitating the loading or unloading of the module by allowing the loading stall to receive or deliver the module.

One variation may provide a method for unloading and loading a module from a loading stall, the module having at least one wheel and a handle, the wheel having at least one wheel detail, the wheel detail being constructed and arranged to facilitate ease of loading and unloading from the loading stall, the loading stall being constructed and arranged to receive the wheel detail. The loading stall may include a latch assist, the latch assist being constructed and arranged to function as a stationary cog that engages the wheel detail, the wheel detail also being constructed and arranged to function as a cog, whereby the wheel detail engages the latch assist and upon rotation of the wheel, the wheel detail and latch assist mesh and the rotational motion of the wheel drives the module into the loading stall. The method may include a user directing the module towards the loading stall and facilitating the loading or unloading of the module by allowing the loading stall to receive or deliver the module.

Another variation may provide a method for unloading and loading a module from a loading stall, the module having at least one wheel and a handle, the wheel having at least one wheel detail, the loading stall being constructed and arranged to receive the wheel detail. The method may include a user directing the module towards the loading stall and facilitating the loading or unloading of the module by allowing the loading stall to receive or deliver the module. The wheel detail may engage the loading stall, the wheel detail being constructed and arranged whereby, upon rotation of the wheel, the wheel detail and the loading stall function cohesively to facilitate the reception or delivery of the module to or from the loading stall, respectively.

Another variation may provide a method for unloading and loading a module from a loading stall, the module having at least one wheel and a handle, the at least one wheel having at least one wheel detail, the loading stall being constructed and arranged to receive the wheel detail. The method may include a user directing the module towards the loading stall and facilitating the loading or unloading of the module by allowing the loading stall to receive or deliver the module. The wheel detail may engage the loading stall, the wheel detail being constructed and arranged whereby, upon rotation of the wheel, the wheel detail and the loading stall function cohesively to facilitate the reception or delivery of the module to or from the loading stall, respectively. The loading stall may include a locking mechanism constructed and arranged to engage the handle. The handle may be constructed and arranged to allow a user to raise or lower the handle, the raising or lowering handle functioning to effectively lock or unlock the module from the loading stall.

According to another variation, the loading stall may be constructed and arranged for receiving or delivering the module via the wheel detail. The loading stall may include a floor, a wall, and a roof. The loading stall may include a channel or plurality of channels or tracks constructed and arranged for guiding and holding the module when the module is loaded into the loading stall or unloaded from the loading stall. The loading stall may also include a ramp constructed and arranged for guiding and holding the module when the module is loaded into the loading stall or unloaded from the loading stall. The loading stall may also include a latch assist that is constructed and arranged for engaging the wheel detail whereby the engagement of the latch assist and the wheel detail facilitates the reception or delivery of the module into or out of the loading stall. The loading stall may be constructed and arranged to contain the module when loaded with the module and to deliver the module out of the loading stall when the module is delivered. The loading stall may be constructed and arranged to facilitate the reception or delivery of a plurality of modules when loaded with modules or to deliver modules out of the loading stall when modules are delivered. The loading stall may define a cavity for holding the module or a plurality of modules.

The module may be made of any suitable material used in the containment and transportation of cargo and freight. Suitable materials may include, but are not limited to, metals, polymers, ceramics, or composite materials. The module may be on any geometry or shape suitable for the containment and transportation of cargo and freight.

The at least one wheel may be made of any suitable material used in the containment and transportation of cargo and freight or in common mobility applications. Suitable materials may include, but are not limited to, metals, polymers, ceramics, or composite materials. The at least one wheel may be of any suitable size or geometry. The at least one wheel may comprise a wheel detail. In one variation, the wheel may have a plurality of wheels details.

The handle may be constructed and arranged to allow a user to raise or lower the handle, the raising or lowering handle functioning to effectively lock or unlock the module from the loading stall or lock mechanism. The handle may also be constructed and arranged to aid a user in moving or directing the module during loading, unloading, or transportation.

The loading stall may be constructed and arranged for receiving or delivering the module via the wheel detail. The loading stall may include a floor, a wall, and a roof. The loading stall may include a channel or plurality of channels or tracks constructed and arranged for guiding and holding the module when the module is loaded into the loading stall. The loading stall may also include a ramp constructed and arranged for guiding and holding the module when the module is loaded into the loading stall. The loading stall may also comprise a latch assist which is constructed and arranged for engaging the wheel detail whereby the engagement of the latch assist and the wheel detail facilitates the reception or delivery of the module into or out of the loading stall. The loading stall may be constructed and arranged to contain the module when loaded with the module and to deliver the module out of the loading stall when the module is delivered. The loading stall may be constructed and arranged to contain a plurality of modules when loaded with modules and to deliver modules out of the loading stall when modules are delivered. The loading stall may define a cavity for holding the module.

The at least one wheel detail may be constructed and arranged to engage the loading stall or the latch assist. The wheel detail may be a protrusion from the wheel. The wheel detail may be an indentation within the wheel. The wheel detail may be of any shape or geometry suitable for engaging the loading stall or the latch assist. In one variation, the wheel detail may be an elongated protrusion or raised rib extending outwardly from a circular face of the wheel and running from the center of the circular face of the wheel to an outer circumference of the wheel.

The above description of variations of the invention is merely illustrative in nature and, thus, variations thereof are not to be regarded as a departure from the spirit and scope of the invention.

What is claimed is:

1. A product comprising:
a module comprising a body and at least one wheel, the body comprising at least one cavity;
the at least one cavity being constructed and arranged to contain or hold cargo or freight; and
the at least one wheel being constructed and arranged to facilitate ease of mobility and navigability of the module over rough terrain or rough surfaces.

2. A product as set forth in claim 1 wherein the at least one wheel has a diameter larger than a largest dimension of the body.

3. A product as set forth in claim 2 wherein the largest dimension of the body is the height of the body.

4. A product as set forth in claim 1 wherein the at least one wheel has a diameter equal to or less than a largest dimension of the body.

5. A product as set forth in claim 1 wherein the module comprises a handle, the handle being attached to the body and constructed and arranged to facilitate ease of mobility and navigability of the module over rough terrain or rough surfaces.

6. A product as set forth in claim 1 wherein the module comprises a motor, the motor being constructed and arranged to drive the at least one wheel.

7. A product as set forth in claim 1 wherein the at least one wheel has at least one wheel detail, the at least one wheel detail being an indentation within the wheel.

8. A product as set forth in claim 1 wherein the at least one wheel comprises a circular face and at least one wheel detail, the at least one wheel detail being a rib on the circular face of the wheel, the rib extending radially outward from the center of the circular face to an outer circumference of the circular face.

9. A product comprising:
a module comprising a body and at least one cavity, at least one wheel, at least one motor, and a loading stall;
the at least one cavity being constructed and arranged to contain or hold cargo or freight;
the motor being constructed and arranged to power the at least one wheel;
the at least one wheel comprising at least one wheel detail, the at least one wheel being constructed and arranged to assist a user in the loading and unloading of cargo from the cavity and to facilitate ease of mobility and navigability of the module over terrain or rough surfaces;
the loading stall being constructed and arranged to receive or deliver the module; and
the at least one wheel detail being constructed and arranged to facilitate the reception or delivery of the module into or out of the loading stall.

10. A product as set forth in claim 9 wherein the at least one wheel has a diameter larger than a largest dimension of the body.

11. A product as set forth in claim 10 wherein the largest dimension of the body is the height of the body.

12. A product as set forth in claim 9 wherein the at least one wheel has a diameter equal to or less than a largest dimension of the body.

13. A product as set forth in claim 9 wherein the at least one wheel comprises a circular face; and
the at least one wheel detail is a rib on the circular face of the wheel, the rib extending radially outward from the center of the circular face to an outer circumference of the circular face.

14. A product as set forth in claim 9 wherein the at least one wheel detail is an indentation within the wheel, the wheel detail extending radially outward from the center of the circular face to an outer circumference of the circular face.

15. A method comprising:
providing a module comprising a body defining at least one cavity, at least one wheel, at least one motor, and a vehicle;
the at least one cavity being constructed and arranged to contain or hold cargo or freight;
the motor being constructed and arranged to power the at least one wheel;
the at least one wheel comprising at least one wheel detail, the at least one wheel being constructed and arranged to assist a user in the loading and unloading of cargo from the cavity and to facilitate ease of mobility and navigability of the module over terrain or rough surfaces;
the vehicle being constructed and arranged to receive or deliver the module; and
the at least one wheel detail being constructed and arranged to facilitate the reception or delivery of the module into or out of the vehicle.

16. The method of claim 15 further comprising loading the module into the vehicle wherein a user moves or directs the module towards the vehicle, the vehicle having a bed having an edge, the at least one wheel detail engages the edge, the motor drives the wheel, and the module is loaded into the vehicle.

17. The method of claim 15 further comprising unloading the module from the vehicle wherein a user moves or directs the module out of the vehicle, the vehicle having a bed having an edge, the at least one wheel detail engages the edge, the motor drives the wheel, and the module is unloaded from the vehicle.

18. The method of claim 15 further comprising providing a loading stall, wherein the loading stall is fixed to the vehicle.

19. The method of claim 18 further comprising loading the module into the loading stall wherein a user moves or directs the module towards the loading stall, the at least one wheel detail engages the loading stall, the motor drives the wheel, and the module is loaded into the loading stall.

20. The method of claim 18 further comprising unloading the module from the loading stall wherein a user moves or directs the module out of the loading stall, the at least one wheel detail engages the loading stall, the motor drives the wheel, and the module is unloaded from the loading stall.
